(19) United States
(12) Patent Application Publication
(10) Pub. No.: US 2005/0033694 A1
(43) Pub. Date: Feb. 10, 2005

(54) System and method for fleet card management

(75) Inventor: Donald R. Perrin, Vienna, VA (US)

Correspondence Address: FINNEGAN, HENDERSON, FARABOW, GARRETT & DUNNER;LLP, 1300 I STREET, NW, WASHINGTON, DC, 20005, US

(73) Assignee: United States Postal Service.

(21) Appl. No.: 10/938,953

(22) Filed: Sep. 13, 2004

Related U.S. Application Data
(63) Continuation-in-part of application No. 10/859,571, filed on Jun. 3, 2004.
(60) Provisional application No. 60/475,247, filed on Jun. 3, 2003.

(51) Int. Cl. G06F 17/60

(52) U.S. Cl. 705/44

(57) ABSTRACT

System and method for managing purchase data of a credit card account associated with a vehicle through the use of a management system. The management system downloads data regarding a vehicle from vehicle master system, and data regarding the U.S. Postal Service organizational hierarchy structure from financial data mart system. The management system receives transaction data from a credit card system, summarizes the data by vehicle, driver, product group and supplier at eight (8) summary levels of organizational structure, analyzes the transaction data for instances of possible fraudulent use of the credit card, and creates exception records to indicate possibility of fraud. On behalf of the credit card provider, the management system creates an invoice and a control report, and sends the invoice to the financial department for payment. The management system produces spreadsheets and reports used for quarterly or annual filing with States to recoup exempt tax not taken off at the pump. The management system organizes the transaction, summary, invoice and exception data into sorted listings for display over one or more intranet web pages. The web pages on which transactions are shown provide the capability for the user to reconcile the transactions. The sorted listings may indicate a probability of fraud.

### CROSS-REFERENCE TO RELATED APPLICATIONS

The present invention is a continuation-in-part of U.S. application Ser. No. 10/859,571 filed Jun. 3, 2003 to Donald R. Perrin and titled SYSTEM AND METHOD FOR FLEET CARD MANAGEMENT. U.S. application Ser. No. 10/859,571 is related to and claims priority of U.S. Provisional Application No. 60/475,247 filed Jun. 3, 2003, in the name of Donald PERRIN, and titled FLEET CARD MANAGEMENT, the contents of which are fully incorporated herein by reference.

### TECHNICAL FIELD

This invention relates generally to managing credit cards accounts, and more particularly, managing the accounting and use of credit cards for vehicles delivering packages and/or mail.

### BACKGROUND

In business today, postal delivery services use vehicles to deliver packages and mail to customers, and to transport mail and packages locally between distribution points and postal stations. The vehicles may belong to a fleet of vehicles, in which each vehicle may originate from a home station. In addition, the home station may be part of a larger network of facilities that maintain vehicles. For example, the United States Postal Service (“U.S. Postal Service”) owns a fleet of vehicles, and may at times rent additional vehicles when necessary. Each vehicle may be primarily domiciled at a home station and each home station may be associated with a vehicle maintenance facility (VMF) or a vehicle post office (VPO). The identifier for both a VMF and a VPO is known as a VMAS (Vehicle Maintenance Accounting System) Location Code. Expanding the network, each VMF or VPO may belong to a district and each district may belong to a business area (BA). In the U.S. Postal Service, each BA may further belong to an Area. For example, BA 1A (the New York Metro P&D) and BA 4A (the New York Metro CSAO) both belong to Area A (New York Metro). Each vehicle owned by USPS has a unique identifier known as the Postal Vehicle Number. In addition, each vehicle may have an associated finance number. Today, the U.S. Postal Service financial organizational hierarchy has 11 Areas, 57 Business Areas, 738 Districts, 199 VMFs and VPOs, and over 32,000 Finance Numbers.

The postal delivery service incurs costs for the day-to-day operation of delivery vehicles such as gasoline and oil and may also incur maintenance costs such as repairs on the vehicle. Drivers of the vehicles may purchase such goods and services for the vehicle on behalf of the delivery service. However, when the number of vehicles in a fleet is large, monitoring and tracking the costs for operation and maintenance becomes increasingly difficult. This may increase the likelihood of mismanagement of resources and funds directed to the operation of the vehicle. This may also increase the likelihood of not detecting instances of fraud.

Thus, it is desirable to provide a management system that facilitates the monitoring and management of credit cards that are used to purchase operational and maintenance goods and services for vehicles in a fleet, and allows for efficiently tracking the incurred costs.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### SUMMARY

In accordance with the invention, there is provided a method for managing a credit card account associated with a vehicle. The method includes sending transaction data regarding a credit card account to a management system; downloading data regarding information on each vehicle; organizing the transaction data to provide a sorted listing of the transaction data associated with each vehicle; and formatting the sorted listing for viewing over an Intranet web page. The sorted listing indicates a likelihood of fraud for the transaction data.

Also provided is a system for managing a credit card account associated with a vehicle. The system includes a management system; a credit card system; and a home station. The credit card system provides the management system with transaction data associated with the credit card account. The management system downloads identifying information associated with the vehicles from the home station, organizes the transaction data into a sorted list associated with the vehicle, and displays the sorted list over an Intranet web page. The sorted list indicates a likelihood of fraud of the transaction data.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1 is a flowchart for a method 100 showing the tasks and steps for managing a credit card account consistent with one embodiment of the invention;

FIG. 2 illustrates a system for fleet card management consistent with one embodiment of the present invention;

FIG. 3 illustrates a computer screen shot for an Intranet home page consistent with one embodiment of the present invention;

FIG. 4 illustrates a computer screen shot for an invoice report consistent with one embodiment of the present invention;

FIG. 5 illustrates a computer screen shot for a product summary consistent with one embodiment of the present invention;

FIG. 6 illustrates a computer screen shot for an exception report consistent with one embodiment of the present invention; and

FIG. 7 illustrates a computer screen shot for a pop-up “Help” window associated with the exception report shown in FIG. 6, consistent with one embodiment of the present invention.

### DESCRIPTION OF THE EMBODIMENTS

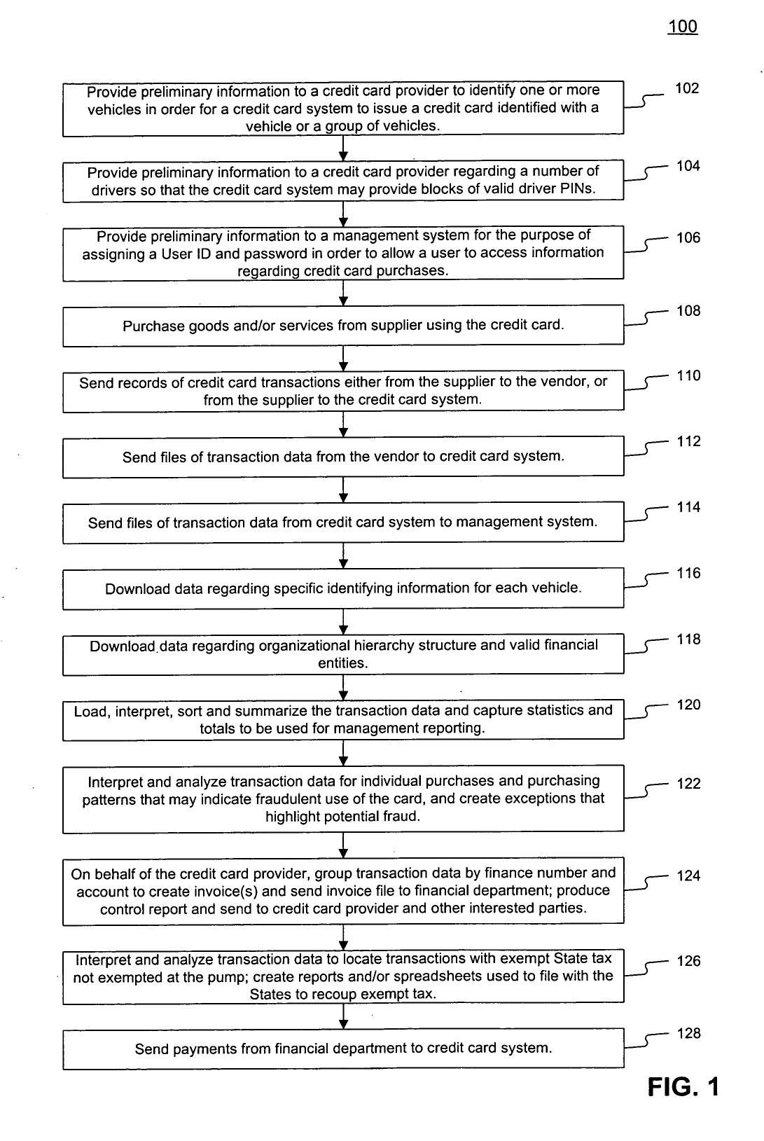

FIG. 1 is a flowchart for a method 100 showing the tasks and steps for managing a credit card account.

Method 100 begins at stage 102 where a user (such as a Postmaster/Postmistress, a driver supervisor or manager at a station, VMF, or VFO), provides preliminary information regarding one or more vehicles to a credit card provider in order for the credit card system to issue a credit card. The credit card is usually identified with a specific vehicle, but in some cases may be identified with a group of vehicles and used for a specific purpose with that group of vehicles, such as vehicle washing. The preliminary information may include a seven (7) digit postal vehicle number, the vehicle's area, district, VMAS location, home station, and finance number. Changes to the preliminary information may also be sent to the credit card system. Based on the preliminary information, the credit card system issues a credit card with the postal vehicle number embossed on the front, and a six (6) digit vehicle identifier assigned by the credit card provider encoded on the magnetic strip on the back. The postal vehicle number and the vehicle identifier will then be received by the credit card system on each transaction for which the card is used.

At stage 104, the user provides information regarding the number of drivers to a credit card provider in order for the credit card system to generate blocks of valid PINs (Personal Identification Numbers) to be provided to the user. Each PIN may be initially assigned a numeric driver number by the credit card system. The user may assign a driver name to each PIN and provide the driver name to the credit card provider to replace the driver number. Either a driver name or a driver number may be received on each transaction.

At stage 106, the user, or any authorized person desiring to access information regarding the management of the credit card account, may provide preliminary information to a management system. The preliminary information may be a request for computer access. An account for the user may be created by the management system, and the user may be assigned a user identification (User ID) and a password in order to access the management system. Users may request access to data from one or more finance numbers, districts, or BAs. Users with BA access to a particular BA may view data for all the districts and finance numbers in the particular BA. Users with access to a particular district may view data for all the finance numbers in the particular district.

At stage 108, the user may purchase goods and services from a supplier, using the credit card. The user may use the PIN generated by the credit card system and assigned to the user, as noted in stage 104. The PIN may be used by the credit card system to identify the user's name. The goods and services may be related to the operation and/or maintenance of the delivery vehicle. For example, the user may purchase gasoline, oil, repair services, or vehicle washing services.

At stage 110, the supplier may send records of transaction data, related to the purchase of goods and/or services by the user, to the vendor (e.g., the supplier's parent company, such as a major oil company). Alternatively, the credit card provider may implement a means by which individual suppliers not associated with a parent company may send a batch of individual transactions directly to the credit card system.

At stage 112, the vendor may send a file of transaction data to the credit card system.

At stage 114, the credit card system may send a file of transaction data related to the purchase of goods and/or services to the management system. The transaction data may include details of credit card transactions that the credit card system received from vendors and/or suppliers during a specified time period (e.g., a week). The information may be sent in a secure manner (e.g., through a firewall) to the management system's database server and loaded into the management system's database. Additionally, the credit card system may send a separate monthly file containing information on payments, adjustments and discounts to the management system.

At stage 116, at specified intervals (e.g., weekly), the management system may also download information from a vehicle master database that may contain identifying information about the vehicle. The vehicle master database may contain a record of all the vehicles, including each vehicle's home district, VMAS location, and finance number. The information about the vehicle may change at any time as vehicles are transferred between home districts, VMAS locations, and finance numbers.

At stage 118, at pre-determined intervals (e.g., weekly), the management system may download information from a financial data mart database that may contain information on the USPS organizational hierarchy structure and valid financial entities. The financial data mart system may be an intranet web system that stores financial data from various U.S. Postal Service financial departments, including information on the USPS organizational hierarchy structure. This information may change at any time as finance numbers are opened, closed, or moved from one BA to another or one district to another. This information may be incorporated into the management system in the form of a drop-down list that allows the users to select specific data. It also may be used to validate finance numbers that may be included in an invoice created by the management system and used to pay the credit card provider, so that invalid finance numbers may not be sent to an accounts payable system as part of the invoice. The organizational hierarchy information may also be used as part of the criteria for summarizing the data to be included in the invoice.

At stage 120, at specified intervals (e.g., weekly), the management system may load, interpret, sort and summarize all data received from the credit card system during the past week, and format it so that it is readable by the user. For example, the management system may summarize and sort the data by vehicle, driver, vendor, and type of product or service purchased (e.g., fuel, oil, washing, repairs, and miscellaneous). The management system may also capture statistics and totals to be used for management reporting. Users with valid user IDs may use the management system to view the summary data and detailed data at any time.

At stage 122, the management system may interpret and analyze the transaction data for individual purchases or purchasing patterns that may indicate fraudulent use of the credit card, and may create exceptions that highlight potential fraud. Exceptions may be categorized as velocity, authorization, usage or finance number exceptions, and may be assigned a high, average or low probability of fraud. A transaction may have one or more exceptions, and an exception may consist of one or more transactions, depending on the nature of the exception to be reported. The users may view the exceptions either in categorized exception reports or by viewing detailed listings of the transaction data that are color coded to indicate that exceptions exist. The categorized exception reports and detailed listings may be hyperlinked to an exception report that provides more information.

At stage 124, on behalf of the credit card provider, the management system may determine the amount owed to the credit card provider for credit card purchases and may create a machine readable invoice or invoices. The invoices may be segmented by valid financial entities (finance numbers) as defined in the organizational hierarchy structure, and by accounts as defined by the financial department. At the same time, the management system may produce a control report that contains invoice totals by credit card account and invoice number, compared with totals received in trailer records on the file received from credit card provider. The trailer records may represent indicators that divide data for one account from that of another account (e.g., to compartmentalize or separate data associated with different accounts in different areas). The control report may be sent to the credit card provider, financial department, and all other interested parties. The management system may send one or more invoices weekly to the financial department to be loaded into the accounts payable system for payment of the outstanding balances to the credit card provider.

At stage 126, the management system may interpret and analyze transaction data to locate transactions where the total amount includes an exempt State tax that may not have been taken off at the time of purchase (e.g., at the time of purchase of gasoline at a pump). The management system may create reports (e.g., in PDF format, and/or spreadsheets) that show individual transactions in this category, the management system may use such reports and/or spreadsheets as a component of a filing with the respective State to recoup exempt taxes.

At stage 128, the financial department may send payments to the credit card provider.

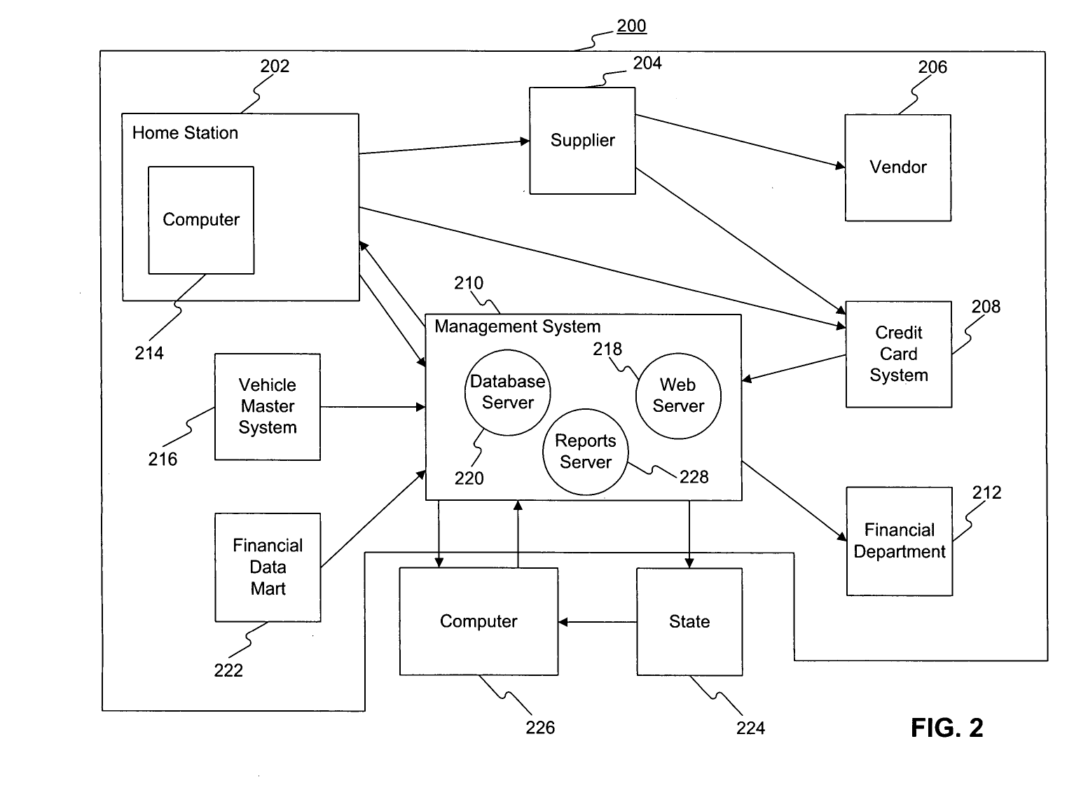

FIG. 2 illustrates a system 200 for management of a credit card, a computer 226, and a state 224. System 200 includes home station 202 (which may include a VMF or VPO), supplier 204, vendor (e.g., supplier's parent company) 206, credit card system 208, management system 210, financial department 212, vehicle master system 216, and financial data mart system 222. Home station may further include computer 214. Management system 210 may further include web server 218, reports server 228, and database server 220.

Home station 202 may include vehicles that are primarily stationed in one area. Users in home station 202 may use computer 214 to supply preliminary information to credit card system 208 and management system 210, as described above in connection with FIG. 1.

Once the user receives a credit card, the user may use the credit card to purchase goods and/or services from supplier 204. Supplier 204 sends the charge to vendor 206 (e.g., supplier's parent company) 206, which sends the credit card transaction information to credit card system 208. Alternatively, supplier 204 sends the charge directly to credit card system 208, for example if the supplier does not have a parent company.

Credit card system 208 sends credit card transaction information to management system 210. Database server 220 receives the transaction data. The transaction data may be received through a firewall to ensure security and integrity of the transmission. The transaction data is in a form that is machine readable, but not easily readable by the user.

The transaction data is stored in a database on database server 220, which also stores information downloaded from vehicle master system 216 and information downloaded from financial data mart system 222. Vehicle master system 216 may be a mainframe system that stores all the vehicle maintenance and accounting information for all the vehicles owned by the U.S. Postal Service, including those within home station 202. Financial data mart system 222 may be an intranet web system that stores financial data from various U.S. Postal Service financial departments, including information on the USPS organizational hierarchy structure.

Management system 210 loads, interprets, sorts and summarizes the transaction data to convert the transaction data into a human-readable format. Management system 210 may also summarize and/or sort the transaction data by different fields which may be used by the user to view the data.

For example, database server 220 may provide the transaction data to the user in fifty-four (54) tables, some of which may be viewed on an Intranet web screen. The fifty-four (54) tables may be classified into six (6) different categories, including, detail tables, summary tables, reference tables, security tables, temporary load tables, and load status tables.

Detail tables may include seven (7) different tables including the following: a product detail table, a discount detail table, a payment-and-adjustment table, an invoice table, a load master table, a customer status table, and an exception lookup table.

The product detail table may contain detailed data about every transaction that is charged to the credit card. It may also contain detailed data about individual transaction reversals. The data may be provided in a form of one (1) row for every different product purchased by each driver for each vehicle.

The discount detail table may contain data on discounts that the postal delivery service may receive from vendors or individual suppliers when those discounts are not included as part of an individual credit card transaction. For example, tiered discounts negotiated with vendors may not take effect until a minimum amount has been purchased over a certain time period and the vendor may give a discount for purchases of specific products above a certain amount per month.

The payment-and-adjustment table may contain data regarding adjustments made to credit card purchases. For example, adjustments may include exempt tax adjustments, vendor or supplier discounts, grouped transaction reversals, and corrections.

The invoice table may include detailed data of invoices created by management system 210 and sent to financial department 212. Format of the invoices is as specified by financial department 212, for loading directly into an accounts payable system.

The load master table may contain data from header records from transactions sent from credit card system 208 to be loaded into management system 210. The header records may represent indicators that divide data for one account from that of another account (e.g., to compartmentalize or separate data associated with different accounts in different areas). The data may be from either a weekly or monthly file.

The customer status table may contain data from trailer records from transactions sent from credit card system 208 to be loaded into management system 210. This data may include record counts and totals for each account within each load; this data may be used to report and validate invoice totals. The trailer records may represent indicators that divide data for one account from that of another account (e.g., to compartmentalize or separate data associated with different accounts in different areas). The data may be from either a weekly or monthly file.

The exception table may contain summary data for each exception that resulted from the analysis of transaction records for the purpose of fraud detection. There may be one record for each exception in the exception table.

The exception lookup table may contain detailed data for the exceptions that resulted from the analysis of transaction records for the purpose of fraud detection. A single exception may be comprised of one or more transactions that show a purchasing pattern typical of one of the various types of fraud. Each transaction may be included in more than one different exception. Hence, there may be multiple records for each exception in the exception lookup table.

Summary tables may include twelve (12) different tables including a product summary table, a vehicle summary table, a driver summary table, a station summary table, an exception summary table, a fuel-without-tax table, a total spend table, a total exempt tax table, a total rebates table, a NECS-recouped table, a tax recouped table, and a reconciled table. These tables are explained in greater detail below.

The product summary table may contain summaries for the total amounts that were charged for various products and service categories, such as fuel, oil, washing, repairs, miscellaneous charges, and exempt taxes. If applicable, the product summary table may also contain summaries for the subtotal amounts that were charged for a particular type of supplier, such as a mobile refueling supplier. The summaries in the product summary table may include totals for each month and year-to-date totals. The summaries in the product summary table may be stored by finance number, BA, district, VMAS location, station, VMAS home area, VMAS home district, and VMAS home location.

The vehicle summary table may contain each vehicle's identification number (vehicle ID) and summaries of the total amounts that each vehicle charged for various products and services, such as fuel, oil, washing, repairs, miscellaneous charges, adjustments, and exempt taxes. The summaries in the vehicle summary table may include totals for each month and year-to-date totals. The summaries in the vehicle summary table may be stored by finance number, BA, district, VMAS location, station, VMAS home area, VMAS home district, and VMAS home location.

The driver summary table may include names of drivers and summaries for the total amount that each driver may be charged for various products and services, such as fuel, oil, washing, repairs, miscellaneous charges, adjustments, and exempt taxes. The summaries in the driver summary table may include totals for each month and year-to-date totals. The summaries in the driver summary table may be stored by finance number, BA, district, VMAS location, station, VMAS home area, VMAS home district, and VMAS home location.

The station summary table may contain summaries for each supplier's parent company name and summaries of the total amounts of each product purchased from the supplier. The totals include total units purchased, total amount charged, average unit cost, number of transactions, total exempt taxes, and total amount invoiced for each month. The summaries in the driver summary table may be stored by finance number, BA, district, VMAS location, station, VMAS home area, VMAS home district, and VMAS home location.

The exception summary table may contain one record for each exception generated during the analysis of transactions for purposes of fraud detection.

The fuel-without-tax table may contain total fuel sales by state and month for transactions for fuel sold without tax (as opposed to fuel sold with tax but with that tax amount exempted, either at the pump or later by filing for recoupment). The fuel-without tax table may be used for management reporting.

The total spend table may contain the total amount spent, by month, for fuel and non-fuel purchases. This table may be used for management reporting.

The total exempt tax table may contain the total amount of tax exempted, by month. This table may be used for management reporting.

The rebates table may contain the total amount of rebates received from the credit card provider, which may be attributable to the use of the credit card.

The NECS-recouped table may contain a total amount of tax recouped by the NECS Corporation from certain states in which the U.S. Postal Service is not eligible to file individually to recoup exempt tax. This table may be used for management reporting. The NECS Corporation is a company that provides sales and fuel tax recovery services including ITFA/IRP filings/audit representations, vehicle titling and licensing, and related consulting services to commercial and government fleet operations.

The tax recouped table may contain totals per quarter (or per year) of monies received back from the States following quarterly or yearly filing by the U.S. Postal Service to recoup exempt taxes that may not be taken off at the time and/or place of purchase (e.g., at the pump). This table may be used for management reporting.

The reconciled table may contain totals and record counts by finance number, month, or for transactions that have been reconciled versus those that have not been reconciled. This table may be used for management reporting.

The reference tables may include sixteen (16) different types of tables, including a master reference table, a copy of the original source reference table, a values table, a VMAS dropdown table, a VMAS mini-master table, a county codes table, a county tax rates history table, a merchant/county correspondence table, a news items table, a parameters table, a relative month table, a state tax rates history table, a general tax rates table, a thresholds history table, a credit card accounts table and a user survey table. These tables are explained in greater detail below.

The master reference table may contain a unique identifier and an identifying name for each finance number, BA, district, station, and VMAS location. A use of the master reference table may be to look up a name of a finance number or organizational unit to display on an Intranet web screen. The master reference table may also be the basis for a dropdown list used to select the U.S. Postal Service financial organizational unit for which the user wishes to display data.

The copy of the original source reference table may be a copy of a reference table from the U.S. Postal Service Financial Data Mart (FDM) system that defines the organizational hierarchy structure for the U.S. Postal Service organization, and may be used to update the master reference table. This copy is refreshed weekly from the data in the FDM system. It may contain finance numbers, BAs, and districts.

The values table may contain various codes that are used in other tables, along with a code identifying a type of code (such as a product code or a vendor code) and a description of a meaning of the code.

The VMAS dropdown table may contain the data that is used to display a dropdown list of VMAS organizational units that may be used to select the specific organization unit as defined by the VMAS system for which the user wishes to display data.

The VMAS mini-master table may contain data about each Postal-owned vehicle, such as the vehicle's make-model code (i.e., type of vehicle), finance number, home area, home district, VMAS location code, disposal date, and date of storage. The data is obtained from a VIC database which is a component of the vehicle master system 216, and may be refreshed weekly. The data in the VMAS mini-master table may be used during the invoice creation portion of the load process by management system 210 to determine which finance number is actually charged for each credit card transaction, i.e., which finance number used when that transaction is invoiced.

The county codes table may contain county codes and names for those counties in which the U.S. Postal Service must identify the county where the transaction occurred in order to file with the county to recoup exempt tax not taken off at the pump.

The county tax rates history table may contain the tax rates for various types of tax by county, for those counties in which the U.S. Postal Service must file with the county to recoup exempt tax not taken off at the pump, and the date range for which that specific tax rate was valid.

The merchant/county correspondence table may contain codes that identify the credit card company's suppliers, and the county code in which that supplier is domiciled. This table may be used to provide county names for filing to recoup exempt taxes in the counties as noted above.

The news items table may contain text for news items to be displayed to users on a “news” web page or on the application's splash screen, and a date range during which each news item should be displayed.

The parameters table may contain the values for parameters that are used by the application or the load programs that may vary from time to time or from one computer platform to another. For example, the parameters may include names and directory paths for report or invoice files.

The relative month table may contain the names, abbreviations and numeric positions of calendar months and their associated fiscal months. For example, October, calendar month 10, may be fiscal month 1 of the U.S. Postal Service fiscal year.

The state tax rates history table may contain the tax rates for various types of tax by state, and the date range for which that specific tax rate was valid.

The general tax rates table may contain information regarding whether the U.S. Postal Service can or cannot file to recoup tax in each state, and which types of tax can be recouped.

The threshold history table may contain threshold values that are used to determine which transactions or groups of transactions qualify to be flagged as exceptions, and a date range for which the specific threshold was valid. For example, four gas purchases per month for a single vehicle may have originally been considered too many, so the original threshold for the associated velocity exception would be four. Experience may subsequently show that four gas purchases per month is normal while five is too many, so the threshold may be changed to five and the date ranges for the two values may show the date ranges during which each different threshold value was valid.

The credit card provider may have multiple accounts for the U.S. Postal Service. The credit card account table may contain the account number for each account and the area that this account represents. The credit card account table may be used during the load process to determine whether a complete or an incomplete file has been received from the credit card provider.

The user survey table may be used to obtain and store answers related to an online survey that USPS may wish to implement, of management system 210 users.

The temporary load tables may include eleven (11) tables that may be used during load processing. The eleven (11) tables may facilitate loading of data into table previously described above. The temporary load tables may serve as temporary holding tables for data transferred from credit card system 208 to be later transferred to management system 210. The eleven (11) tables include a temporary detail table, a temporary driver summary table, a temporary product summary table, a temporary station summary table, a temporary vehicle summary table, a temporary driver work table, a temporary vehicle work table, a temporary station work table, a temporary detail work table, a temporary exception table, and a temporary exception lookup table.

The temporary detail table may contain detailed transaction data received from the credit card system. This detailed transaction data may be loaded into the temporary detail table to begin a load process. After the load processing is completed, the data may be transferred to the product detail table.

The temporary driver summary table may contain summary data for each driver. Management system 210 may calculate summary data by summing the data in the temporary detail table by driver, at each of the organization structure hierarchy levels. When all the load processing steps have been successfully completed, the data in the temporary driver summary table may be moved to the driver summary table.

The temporary product summary table may contain summaries of the total amounts that were charged for various products and services, such as fuel, oil, washing, repairs, miscellaneous charges, adjustments, and exempt taxes. Management system 210 may calculate the summary data by summing the data in the temporary detail table by product group, at each organizational hierarchy structure level. When all the load processing steps have been completed, the data in the temporary product summary table may be transferred to the product summary table.

The temporary station summary table may contain summary data for each major parent company 206, such as an oil company. Management system 210 may calculate the summary data by summing the data in the temporary detail table by parent company 206, at each of the organization hierarchy structure levels. When all the load processing steps have been completed, the data in the temporary station summary table may be moved to the station summary table.

The temporary vehicle summary table may contain summary data for each vehicle. Management system 210 calculates the summary data by summing the data in the temporary detail table by vehicle, at each of the organizational hierarchy structure levels. When all the load processing steps have been completed, the data in the temporary vehicle summary table may be moved to the vehicle summary table.

The temporary vehicle work table may contain interim data produced during the process of calculating the data to be stored in the temporary vehicle summary table.

The temporary driver work table may contain interim data produced during the process of calculating the data to be stored in the temporary driver summary table.

The temporary station work table may contain interim data produced during the process of calculating the data to be stored in the temporary station summary table.

The temporary detail work table may contain interim data produced during the process of calculating the data to be stored in the temporary detail table.

The temporary exception table may contain interim data produced during the process of creating exceptions to be stored in the temporary exception table.

The temporary exception lookup table may contain interim data produced during the process of creating exception lookup information to be stored in the temporary exception lookup table.

Load status tables may include three (3) tables that may indicate the status or progress of data being loaded during the load processes as described above. The three (3) tables include a database status table, a load log table, and a load progress table.

The database status table may contain a single column, which may be set to “1” when a load is in progress or set to “0” at other times. The purpose of the database status table may be to prevent more than one load process from running at the same time. The database status table may also lock out users from a web screen when the load process is transferring data from temporary tables to permanent tables at the end of the load process.

The load log table may contain information regarding the overall result of each load process that is run. If a load process should fail, this information may be written to the load log table. The load log table may be used to prevent a subsequent load process from running until the previous error has been corrected and the failed load process has been completed correctly.

The load progress table may contain messages that load procedures associated with management system 210 may write out to document results of each individual step of the load process. The messages may indicate completion when each step is successful, provide specific error messages and diagnostics when a step fails, and provide an audit trail for people who may support management system 210.

Management system 210 may load both weekly and monthly files from credit card system 208. The weekly file may be downloaded automatically from the credit card system 208 to database server 220 on a weekly basis (e.g., every Saturday afternoon), then loaded into the temporary detail table and processed automatically by management system 210 every Saturday evening. The monthly file may be downloaded from the credit card system 208 to database server 220 automatically on or about the 22^{nd} of each month or at the time when the credit card provider performs a monthly close. The monthly file is loaded automatically into the payments-and-adjustments table and discount details table, and held in suspense to be processed automatically by management system 210 during weekly processing on the next Saturday. The process of automatic loading may be implemented using one or more Oracle PL/SQL packages and/or procedures.

Management system 210 may load a source reference file extracted automatically by management system 210 from the Financial Data Mart system 222, via a database link. This may occur on a weekly basis. This source reference file is loaded automatically into the copy of the original source reference table. It may then be compared against the master reference table so that new entities in the U.S. Postal Service organizational hierarchy structure (e.g., new BA5, new districts, and new finance numbers) may be added, entities that have been moved to a different position in the hierarchy may be updated, and any entities that have been deleted from the U.S. Postal Service hierarchy may be marked “invalid” but left in place so that existing data for those entities will remain accessible. The process of automatic loading may be implemented using one or more Oracle PL/SQL packages and/or procedures.

Management system 210 may load a file extracted from the VIC database, which is a component of the vehicle master system 216. This may occur on a weekly basis. A VIC extract file may be automatically extracted and sent to database server 220 every Saturday morning via a scheduled batch job run on the mainframe against vehicle master system 216. The VIC extract file may be loaded into management system 210 automatically every week just before the weekly file received from credit card system 208 is loaded. The process of automatic loading may be implemented using one or more Oracle PL/SQL packages and/or procedures.

At intervals specified by the States (usually quarterly), using reports server 228, management system 210 may produce spreadsheets, and/or reports in PDF format, that show tax exempt credit card transactions for which exempt tax was not taken off at the pump. These spreadsheets and/or reports may be copied to a CD and sent to an appropriate state 224 for processing (e.g., State 224). Management system 210 may be updated by authorized users via web pages with the amount of the refund applied for. Refund checks may be subsequently received from the states and management system 210 may be subsequently updated with the date and amount of these checks entered by authorized U.S. Postal Service managers using computer 226.

The management system 210 may be accessible through an Intranet connection from computer 214, via web server 218, which connects to database server 220. Through this connection one or more web pages may be displayed so that the user (e.g., the driver or another authorized person), located at a home station, VMF or VPO 202 can use computer 214 to access information regarding the credit card account. This allows users to gain access to transactions that originated in credit card system 208, and also the summary data, exceptions and invoices produced by management system 210. The users may view summary data in a variety of different ways and may access detailed information regarding individual transactions.

The management system 210 may be accessible through an Intranet connection from computer 226, via web server 218, which connects to database server 220. Through this connection one or more web pages may be displayed so that authorized U.S. Postal Service managers can use computer 226 to access the information listed above plus various management reports detailing items such as a total amount spent, a total exempt tax taken off at the pump, a total exempt tax recouped from the States, total rebates, total discounts and adjustments, and a number and a total dollar amount of transactions that are reconciled versus those that are non-reconciled.

In addition, the management system 210 may issue user IDs and passwords that may specify the business area(s) and/or finance number(s) and/or district(s) for which each user may view data regarding the credit card account. A user with business area access may view data for all the districts and finance numbers within that business area; a user with district access may view data for all the finance numbers within that district; and a user with finance number access may view data only for the finance numbers specified.

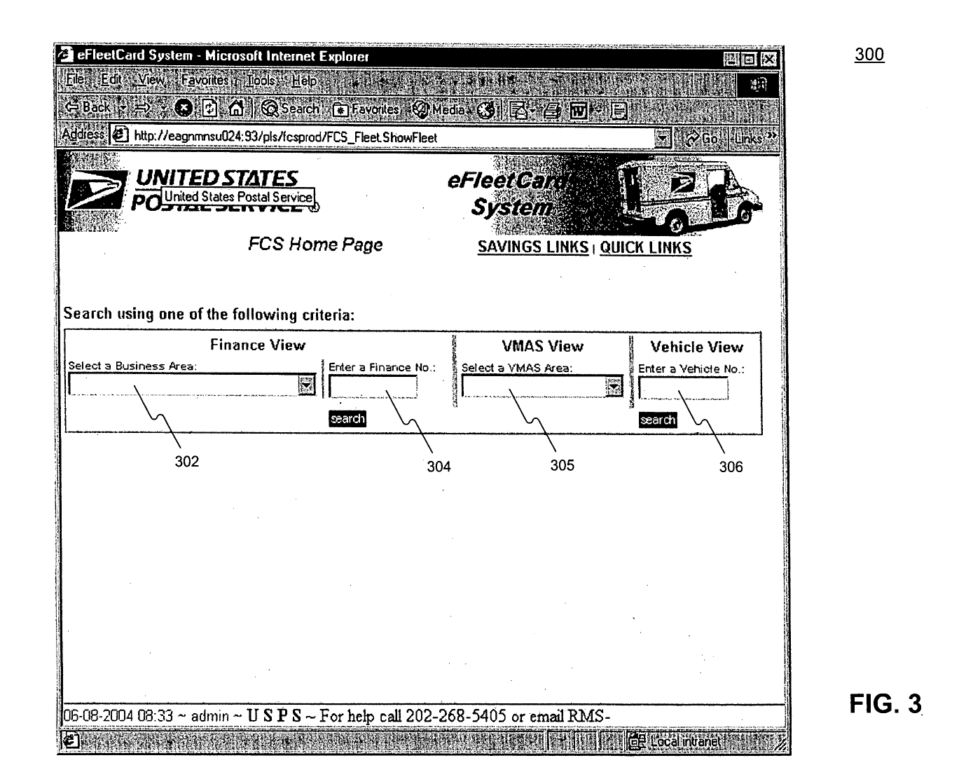

FIG. 3 shows an illustrative screen shot of an Intranet home page 300 consistent with one embodiment of the present invention. Screen shot 300 includes drop down lists 302 and 306 and text boxes 304 and 308.

Intranet page 300 may be accessed after a user has successfully logged in, using his or her User ID and password. The user may choose to select data in different ways, including by business area, finance number, VMAS area, and vehicle. List 302 may allow the user to select a business area. List 306 may allow the user to select a VMAS area. Text box 304 may allow the user to type a finance number to search. Text box 308 may allow the user to type a vehicle number to search.

To specify a business area, a user may click on the drop-down list under a “Select a Business Area” heading. The management system may display available business areas (BA). If the user selects one of the business areas, the system may display a list of financial organizational units within the selected BA, e.g., the BA itself, all its districts and finance numbers, and the VMAS locations and stations within each district. Further, once a financial organizational unit is selected, a list of accounting periods or months may be displayed for the user to select.

To specify a finance number, a user may type the desired finance number into the text box then click on the “search” button. The management system may display that finance number and all the stations found under that finance number. Once a finance number or station is selected, a list of accounting periods or months may be displayed for the user to select.

To specify a VMAS area, a user may click on the drop-down list under the “Select a VMAS Area” heading. The management system may display all available VMAS Areas. If the user selects one of the areas, the system may display a list of VMAS organizational units within the selected Area, e.g., the VMAS Area itself, all its VMAS home Districts and VMAS home locations. (Note: VMAS home districts and VMAS home locations for a vehicle do not necessarily equate to the Districts and VMAS locations under which that vehicle will be found in the financial organization). Once a VMAS organizational unit is selected, a list of accounting periods or month may be displayed for the user to select.

To specify a vehicle, a user may type the desired vehicle number into the text box then click on the “search” button. Once a vehicle number is found selected, a list of accounting periods or months may be displayed for the user to select.

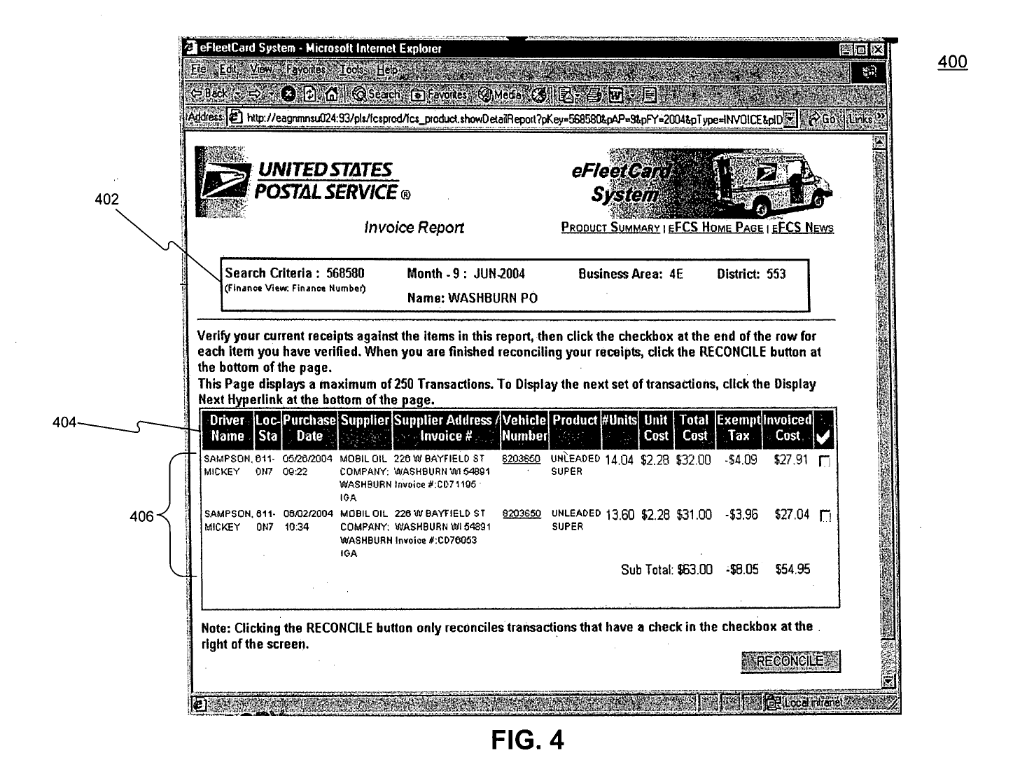

The management system may also offer the user a number of pages in order to view detailed views of the transactional data. For example, FIG. 4 illustrates a screen shot of an invoice report 400. Invoice report 400 includes identification field 402, headings 404, and data 406.

Identification field 402 may include information such as the business area, district, name, search criteria, and month that identifies the invoice report. Headings 404 may show a driver's name, a local station, a purchase date, a supplier, a supplier address, a vehicle number, a product, a quantity of units, a unit cost, a total cost, an exemption amount for taxes, an invoiced cost, and a checkmark icon to indicate a user updateable reconciliation checkbox. Data 406 corresponds to headings 404 showing the detailed data for finance number 568580.

Invoice report 400 may also indicate exceptions through color coding. An exception may be a transaction that is flagged for a possible instance of fraud or misuse of the credit card or possible errors in the use of the credit card. Possible instances of fraud may include too many transactions of a specified type within a specified time, using the card for personal use items such as food, or display of conflicting goods such as unleaded fuel and diesel fuel for the same vehicle.

Data 406 may contain a checkbox which may be clicked by the user to indicate that the individual transaction has been reconciled, e.g., a specific credit card receipt has been found to match that individual transaction. U.S. Postal Service policy may specify that each transaction must either be reconciled, or if a matching credit card receipt cannot be found, that action must be taken to apply for credit with the credit card provider and report possible fraud to the appropriate authorities. Data from the reconcile checkboxes may be used for management reporting to make sure that U.S. Postal Service policies are being followed.

Data 406 may be displayed with different colors to indicate a likelihood of fraud. Red color entries may indicate exceptions with a high probability of fraud. Blue color entries may indicate exceptions with an average probability of fraud. Purple color entries may indicate exceptions with a low probability of fraud. Each transaction with a color coded exception may further have a vehicle number hyperlink. The user may click on this hyperlink to navigate to a web page that shows the specific exception and any other transactions that may be participants in the same exception, and contains further hyperlinks to web pages that explain the exception and its possible causes in detail, and suggest actions to be taken to resolve it, including reporting incidents of possible fraud to the appropriate authorities.

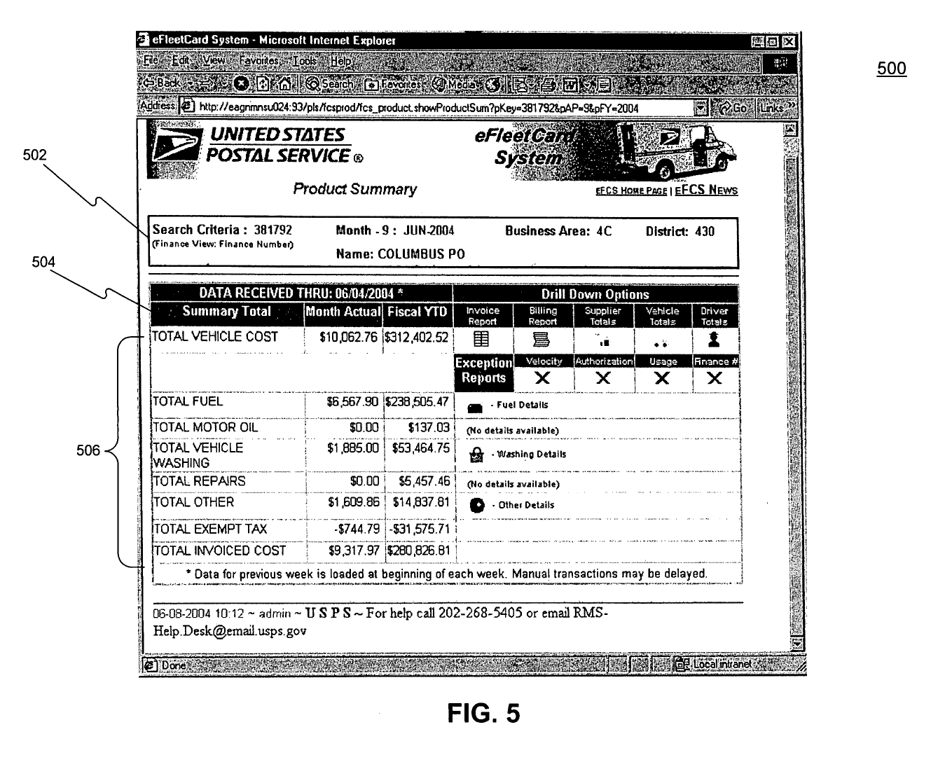

FIG. 5 illustrates a screen shot of a product summary 500. Product summary 500 includes identifying information field 502, headings 504, and data 506.

Identifying information 502 may identify basic information to which product summary 500 pertains. For example, product summary 500 regards search criteria 381792, Month 8 of Fiscal Year 2004, business area 4C, district 430, and a name of Columbus PO. Headings 504 shows different fields such as a summary total, month actual cost, a year to date cost, and drill down options. Drill down options may allow the user to view more detailed analysis of the transaction data, including an invoice report, billing report, supplier summary, vehicle summary, driver summary, five different types of product group summaries, and four different types of exception reports. Data 506 corresponds to headings 506 and shows summary product types, cost figures, and icons that may be used as links to navigate to various other reports.

Product summary 500 may provide links to show other summary and detail reports for all vehicles and drivers in the selected organizational unit. For example, by clicking on a yellow “invoice report” icon the user may access a web page that shows the invoice report (e.g. a detail transaction list sorted by vehicle number). By clicking on a yellow “billing report’ icon the user may access a web page that shows the billing report (e.g. a detail report that shows the specific invoice line items that apply to the selected organizational unit in the invoice created by the management system to pay the credit card provider, and from which the user can drill down to individual transactions). By clicking on a green “gas station” icon the user may access a web page that shows the supplier summary, which may be summary totals by product for each vendor (e.g., supplier parent company). By clicking on a blue “truck” icon the user may access a web page that shows the vehicle summary (e.g., summary totals by vehicle, from which the user may link to individual transactions). By clicking on a gray-blue “person” icon the user may access a web page that shows the driver summary (e.g., summary totals by driver, from which the user may link to individual transactions).

Product summary 500 may provide links to show product group details for all vehicles and drivers in the selected organizational unit, sorted by transaction date. For example, by clicking on a red “gas can” icon the user may access a web page that shows detail fuel transactions; by clicking on a gray “oil can” icon the user may access a web page that shows oil transactions. By clicking on a gold “wash bucket” icon the user may access a web page that shows detailed vehicle washing transactions. By clicking on a blue “wrench” icon the user may access a web page that shows detailed repair transactions. By clicking on a purple “ball” icon the user may access a web page that shows detailed transactions that do not fit in any of the other product group categories.

Product summary 500 may provide links to show exception reports for all vehicles in the selected organizational unit. (Note: in this embodiment exceptions are defined to occur at the vehicle level and not at the driver level). For example, by clicking on a red “X,” a user may access a web page that shows all velocity exceptions; by clicking on a blue “X,” the user may access a web page that shows all authorization exceptions; by clicking on a purple “X,” the user may access a web page that shows all usage exceptions; and by clicking on a green “X,” the user may access a web page that shows all finance number exceptions (e.g., cases where the finance number provided for a vehicle was invalid and could not be used on the invoice sent to the accounts payable system maintained by financial department 212; in such cases an area default finance number must be substituted).

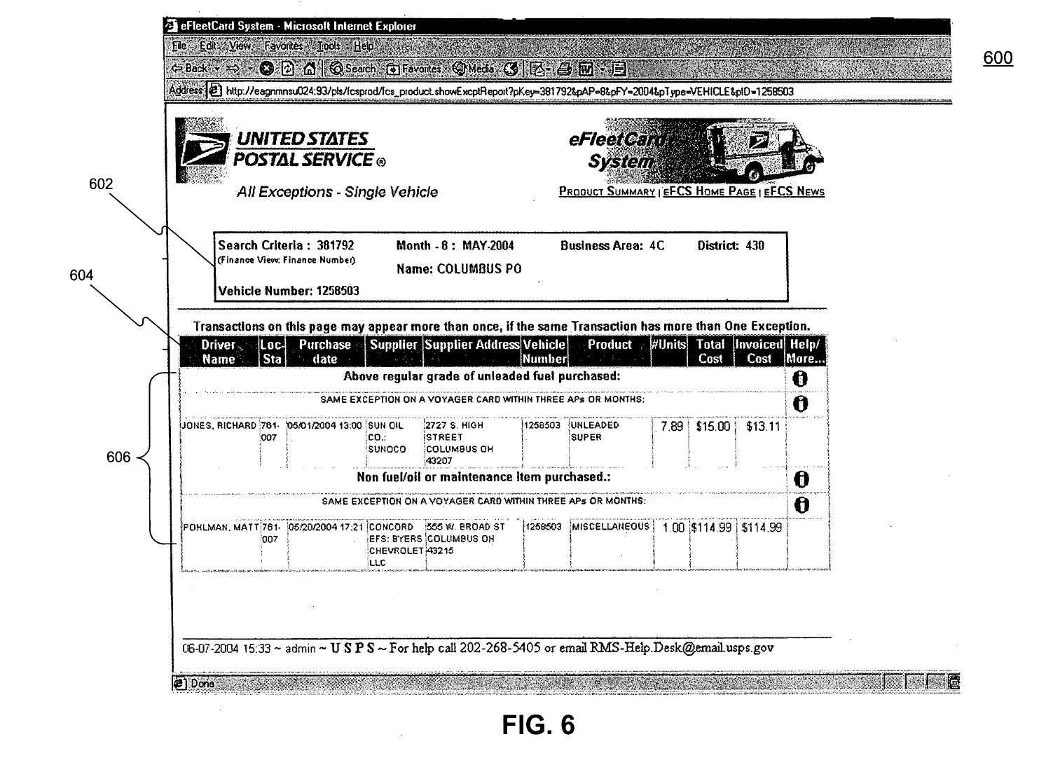

FIG. 6 illustrates a screen shot of an exception report 600. Exception report 600 includes identifying information field 602, headings 604, and data 606.

Identifying information 602 may identify basic information to which exception report 600 pertains. For example, exception report 600 regards search criteria 381792, Month 8-2004, business area 4C, district 430, and a name of Columbus PO. Headings 604 shows different fields such as a driver name, location and station, purchase date, supplier, supplier address, vehicle number, product, number of units, total cost, invoiced cost, and a help option. Help options may allow the user to view more detailed information about the exception. Data 606 corresponds to headings 606.

Exception report 600 may provide for each exception a “Help” link to show more detailed information about the exception, such how it could occur and what action might be taken to resolve it. For example, by clicking on a yellow “I” within a red circle, a user may access a pop-up “Help” window that shows an explanation for what might have caused the exception to occur, and suggested action to take to resolve it.

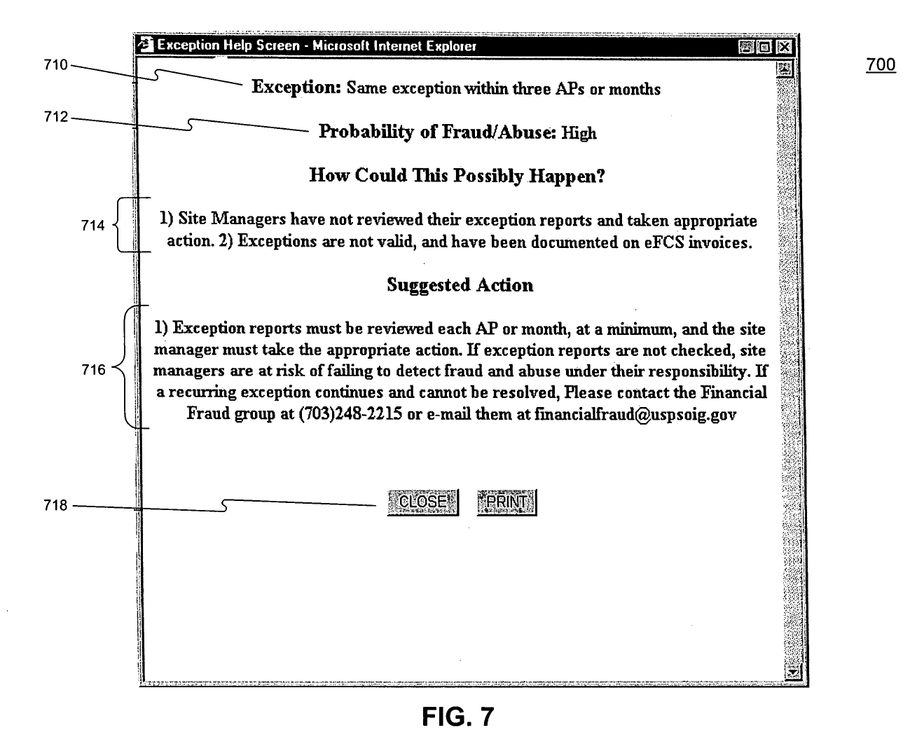

FIG. 7 illustrates 6 illustrates a screen shot of a pop-up “Help” window 700. Pop-up “Help” window 700 includes exception description 710, probability of fraud 720, explanation of how the exception could occur 730, suggested action 740 and buttons 750.

Exception description 710, probability of fraud 720, explanation of how the exception could occur 730, and suggested action 740 are table driven and can be changed at the direction of the responsible the U.S. Postal Service manager.

Buttons 750 may allow the user to either close the pop-up “Help” window, or print the contents of the pop-up “Help” window for future reference.

Management system 210 may also provide other screens for the user to view data regarding transactions on the credit card account.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for managing a credit card account associated with a vehicle comprising:
sending transaction data regarding a credit card account to a management system;
downloading data regarding information on each vehicle;
organizing the transaction data to provide a sorted listing of the transaction data associated with each vehicle; and
formatting the sorted listing for viewing over an Intranet web page;
wherein the sorted listing indicates a likelihood of fraud for the transaction data.

2. The method of claim 1, further comprising providing the management system with identifying information for issuance of a user ID and password in order to access the sorted listing.

3. The method of claim 2, wherein the user ID and password allow access to information associated with the provided identifying information.

4. The method of claim 1, further comprising creating and sending an invoice to an internal financial department based upon the transaction data.

5. The method of claim 4, further comprising sending payment associated with the invoice to a credit card provider.

6. The method of claim 1, further comprising:
providing information to a credit card company identifying a driver and the vehicle; and
issuing a credit card account associated with the vehicle to the user.

7. The method of claim 1, further comprising:
displaying the sorted listing according to data located in at least one of a detail table, a summary table, a reference table, a security table, a temporary load table, and a load status table in the management system.

8. The method of claim 1, further comprising:
displaying the sorted listing on an Intranet web page, wherein the sorted listing is viewable by at least one of vehicle, driver, supplier, and type of product purchased.

9. The method of claim 1, wherein the likelihood of fraud is represented by a color coded scheme viewable over the Intranet webpage.

10. A system for managing a credit card account associated with a vehicle, comprising:
a management system;
a credit card system; and
a home station;
wherein the credit card system provides the management system with transaction data associated with the credit card account;
wherein the management system downloads identifying information associated with the vehicles from the home station, organizes the transaction data into a sorted list associated with the vehicle, and displays the sorted list over an Intranet web page; and
wherein the sorted list indicates a likelihood of fraud of the transaction data.

11. The system of claim 10, wherein the management system includes a server for receiving the transaction data and a database for storing the transaction data and the identifying information associated with the vehicle.

12. The system of claim 11, wherein the server receives the transaction data through a firewall.

13. The system of claim 10, further comprising a financial department;
wherein the management system creates and sends invoices to the financial department; and
the financial department sends payment associated with the invoice to the credit card system.

14. The system of claim 11, wherein the management system issues a user ID and password associated with supplied information for access to the Intranet web page.

15. The system of claim 11, wherein the sorted list is displayed to according to data located in a detailed table, a summary table, a reference table, a security table, a temporary load table, and a load status table in the management system.

16. The system of claim 11, wherein the sorted listing is displayed on an Intranet web page by at least one of vehicle, driver, supplier, and type of product purchased.

17. The system of claim 10, wherein the likelihood of fraud is represented by a color coded scheme viewable over the Intranet webpage.
